(19) United States
(12) Patent Application Publication
(10) Pub. No.: US 2016/0177899 A1
(43) Pub. Date: Jun. 23, 2016

(54) FUEL SUPPLY SYSTEM FOR INTERNAL COMBUSTION ENGINE

(71) Applicant: Caterpillar Inc., Peoria, IL (US)

(72) Inventors: Craig M. Ross, Chillicothe, IL (US); Joseph S. Burkitt, Edwards, IL (US)

(73) Assignee: Caterpillar Inc., Peoria, IL (US)

(21) Appl. No.: 15/058,177

(22) Filed: Mar. 2, 2016

(51) Int. Cl. F02M 37/00; F02M 59/44

(52) U.S. Cl. CPC F02M 37/0052; F02M 37/0076; F02M 59/44

(57) ABSTRACT

A fuel supply system for an internal combustion engine is provided. The fuel supply system includes a fuel tank, at least one fuel injector, a fuel supply line and a fuel return line. The fuel supply line is adapted to supply fuel from the fuel tank to the at least one fuel injector. The fuel supply line supplies the fuel via a first pump, a first filter module, a second pump, a second filter module, a third filter module and a third pump. The fuel return line is adapted to return the fuel from the at least one fuel injector to an inlet of the second filter module. The fuel returned from the at least one fuel injector and supplied to the second filter module facilitates in maintaining a consistent back pressure and removing debris from the fuel supply system.

### TECHNICAL FIELD

The present disclosure relates to fuel supply systems in engines and more specifically, to a fuel supply system in an internal combustion engine for providing consistent back pressure to fuel injectors.

### BACKGROUND

Internal combustion engines, for example diesel engines, employ a fuel injector back pressure regulator or a fuel injector return check valve for routing a fuel leakage back to a fuel tank. The fuel supplied to the fuel tank of the engine from a fuel pump installed at a fuel station contains debris or dirt that can in turn hamper the operation of diesel engine. Therefore, fuel supply systems of the engines employ one or more filters to filter out any contamination from the fuel. Also, unused fuel returned from the fuel injectors via a fuel return line may contain a degree of contamination due to rusting of injector components, or any other reason. As a result, there are chances of accumulation of dirt and debris in the fuel supply system around the fuel injector back pressure regulator (here after referred in the specification as injector pressure regulator), especially in the engines of heavy machines. The accumulation of the debris causes the injector pressure regulator to plug and stick open. Hence, the injector pressure regulator is unable to maintain a consistent back pressure on the fuel injectors. This leads to cavitation in the injector. Cavitation leads to formation of bubbles in the fuel or empty spaces around the injector.

U.S. Pat. No. 6,964,267, hereinafter referred to as '267 reference, discloses a diesel engine fuel supply system for reducing fuel pressure loss. The fuel supply system includes a fuel supply line for providing fuel from a fuel tank to a fuel injector through a prime pump and fuel filter. A first fuel return line is adapted to return the residual fuel in the fuel injector to the fuel tank. A second fuel return line is adapted to return the residual fuel in the fuel injector to the fuel filter. A heater heats up the fuel passing through the second fuel return line. A bypass line is provided to supply the fuel to the fuel injector through the fuel filter without passing through the prime pump. However, the '267 reference fails to disclose a fuel system that maintains a consistent back pressure to the fuel injectors. Also, the '267 reference fails to provide a system for filtering out debris from the fuel supply system. Therefore, there is a need of a fuel supply system that functions without the fuel injector back pressure regulator and still maintains consistent back pressure while also filters out the debris from the fuel supply system.

### SUMMARY OF THE DISCLOSURE

In one aspect of the present disclosure, a fuel supply system for an internal combustion engine is provided. The fuel supply system includes a fuel tank, at least one fuel injector, a first pump, a second pump, a third pump, a first filler module, a second filter module and a third filter module, a fuel supply line and a fuel return line The fuel supply line is adapted to supply fuel from the fuel tank to the at least one fuel injector. The fuel supply line supplies the fuel via the first pump, the first filter module, the second pump, the second filter module, the third filter module and the third pump. The fuel return line is adapted to return the fuel from the at least one fuel injector to an inlet of the second filter module. The fuel returned from the at least one fuel injector and supplied to the second filter module facilitates in maintaining a consistent back pressure and removing debris from the fuel supply system.

Other features and aspects of this disclosure will be apparent from the following description and the accompanying drawings.

### BRIEF DESCRIPTION OF THE DRAWINGS

FIG. 1 is a schematic view of a vehicle utilizing proposed fuel supply system, in accordance with the concepts of the present disclosure;

FIG. 2 is a schematic view of the fuel supply system, in accordance with the concepts of the present disclosure; and

FIG. 3 is a schematic view of the fuel supply system having a re-circulating line in a different configuration, in accordance with an embodiment of the present disclosure.

### DETAILED DESCRIPTION

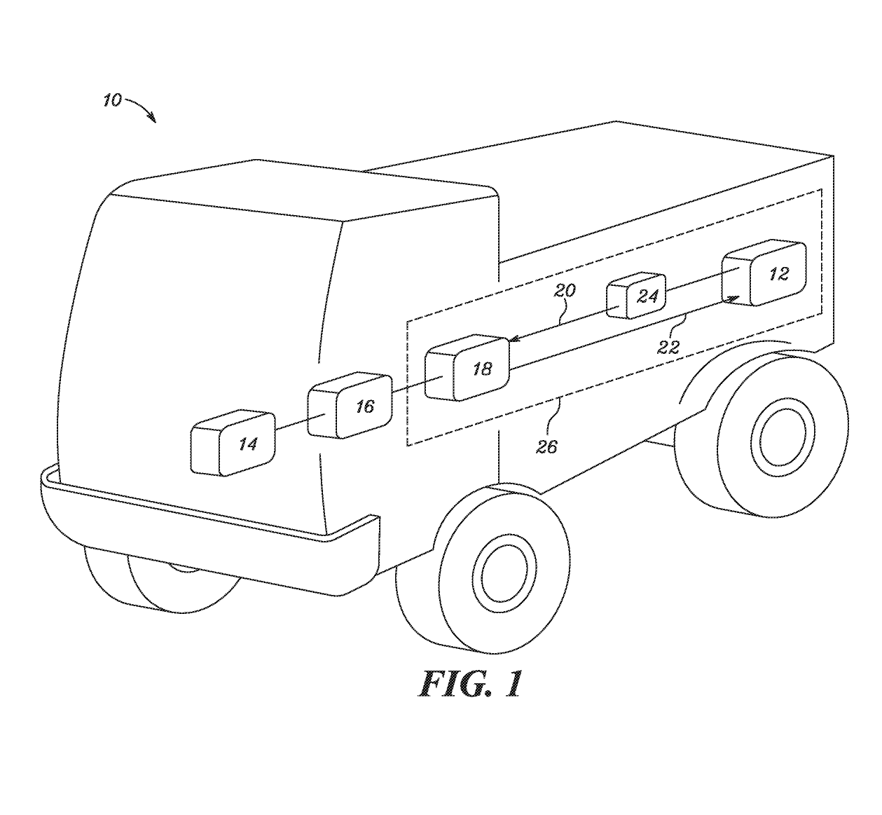

Referring to FIG. 1, a vehicle 10 includes a fuel tank 12 that supplies fuel to an internal combustion engine 14. The internal combustion engine 14 includes an engine cylinder 16 and a fuel injector 18. The engine cylinder 16 is supplied with the fuel by the fuel injector 18. The fuel is delivered from the fuel tank 12 to the fuel injector 18 (also fuel injectors 18) via a fuel supply line 20. It will be apparent to the one skilled in the art that the vehicle 10 uses other components (not shown) to inject fuel in the engine cylinder 16 depending on the requirement and/or design without departing from the meaning and scope of the present disclosure.

During operation of the internal combustion engine 14, a portion of the injected fuel is leaked from the fuel injector 18. Therefore, the leaked fuel in the fuel injector 18 is routed hack to the fuel tank 12 via a fuel return line 22. The fuel supply line 20 includes a filler 24 to filter any contamination, like dust or debris, from the fuel before the fuel is supplied to the engine cylinder 16. It will be apparent to the one skilled in the art that there is more than one filter employed in the fuel supply line 20 for filtration of fuel depending on the design and requirement without departing from the meaning and scope of the present disclosure. A fuel supply system 26 includes the fuel tank 12, the fuel injector 18, the fuel supply line 20, the fuel return line 22 and the filter 24.

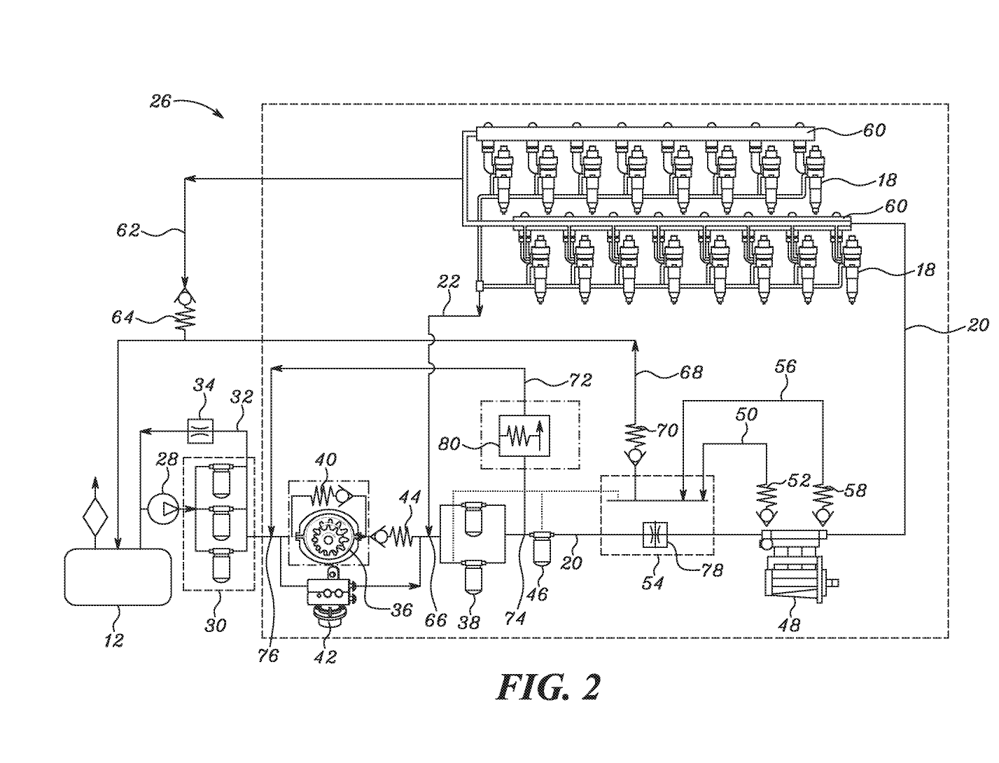

Referring to FIG. 2, the fuel supply system 26 includes the fuel tank 12 that supplies the fuel to the fuel injector 18. The fuel supply system 26 includes a first pump 28 to pump the fuel through a first filter module 30. In an embodiment, the first pump 28 is a CFM (Clean Fuel Module) pump. A flow line 32 supplies any leaked fuel from the first filter module 30 to the fuel tank 12 via an orifice 34, thereby re-circulating the fuel in the fuel supply system 26.

From the first filter module 30, a second pump 36 pumps the fuel towards a second filter module 38. In an embodiment, the second pump 36 is either a fuel transfer pump or a priming pump depending on whether the internal combustion engine 14 of the vehicle 10 is operating normally or through priming. The second filter module 38 provides a second degree of filtration to filter any remaining debris, dust or rust from the fuel. A check valve 40 and a component 42 are arranged parallel to the second pump 36. A check valve 44, being unidirectional, keeps a check on flow of the fuel from the second pump 36 to the second filter module 38 and restricts the fuel from flowing back to the second pump 36. Passing through the second filter module 38, the fuel flows through a third filter module 46 to provide a third degree of filtration to the fuel.

After being filtered from the third filter module 46, the fuel is supplied to a third pump 48. The third pump 48 is a high pressure pump increasing the pressure of the fuel and supplying a pressurized fuel to the fuel injector 18. Also, a leakage line 50 with a fluid circulation valve 52 circulates the fuel from the third pump 48 to a mono-block assembly 54. A flow relief line 56 directs the fuel from the third pump 48 to the mono-block assembly 54 via a check relief valve 58. The fuel injector 18 injects the pressurized fuel to the engine cylinder 16. The fuel injector 18 is mounted on a common rail 60, which is in fluid communication with the fuel supply line 20. The common rail 60 is generally two walled, including, an inner wall (not shown) and an outer wall (not shown). In certain situations, there is a fuel leakage through the inner wall (not shown) to the outer wall (not shown). In such situations, a leakage line 62 returns the leaked fuel to the fuel tank 12 via a check valve 64. The check valve 64 restricts the flow of the fuel from the fuel tank 12 to the fuel injector 18 via the common rail 60.

During operation of the internal combustion engine 14, there are chances of fuel leakage in the fuel injector 18 that leads to wastage of fuel. Therefore, such fuel leakage in the fuel injector 18 is re-circulated back to the fuel supply line 20 via the fuel return line 22. The fuel return line 22 is adapted to return the fuel from the fuel injector 18 to an inlet 66 of the second filter module 38. In other words, the fuel return line 22 routes the excess or leaked fuel from the fuel injector 18 to a discharge of the second pump 36. The connection of the fuel return line 22 with the inlet 66 of the second filter module 38 facilitates in maintaining a consistent back pressure and removing debris from the fuel supply system 26. Further, the fuel is routed through two stages of filtrations via the second filter module 38 and the third filter module 46 to eliminate any debris or dirt still left in the fuel, Thereafter, the fuel is routed back to the fuel injector 18 passing via the third pump 48. Any fuel leakage in the fuel injector 18 is routed back to the fuel injector 18 while being filtered again to remove any contamination in the fuel. This arrangement maintains the consistent back pressure to the fuel injector 18 and the second filter module 38 in the fuel supply system 26.

Further, a pressure regulating line 68 keeps a check on return flow of the fuel to the mono-block assembly 54 to prevent drain clown by utilizing a check valve 70. Also, a re-circulating line 72 re-circulates the fuel from an outlet 74 of the second filter module 38 to an inlet 76 of the second pump 36. Through the re-circulating line 72, the fuel is routed back to the second pump 36, and supplied to the second filter module 38 and the third filter module 46. In an embodiment, the re-circulating line 72 is installed with a pressure regulator 80,

It will be apparent to the one skilled in the art that the fuel supply system 26 employs check valves or flow control valves to keep a check on the direction and amount of the fuel flow depending on the requirement without departing from the meaning and scope of the present disclosure. The fuel supply system 26 includes various other elements such as orifices, pumps, pressure regulators, air vents, sensors, and others that are not labeled or illustrated in the FIG. 2 for simplicity in description without departing from the meaning and scope of the present disclosure.

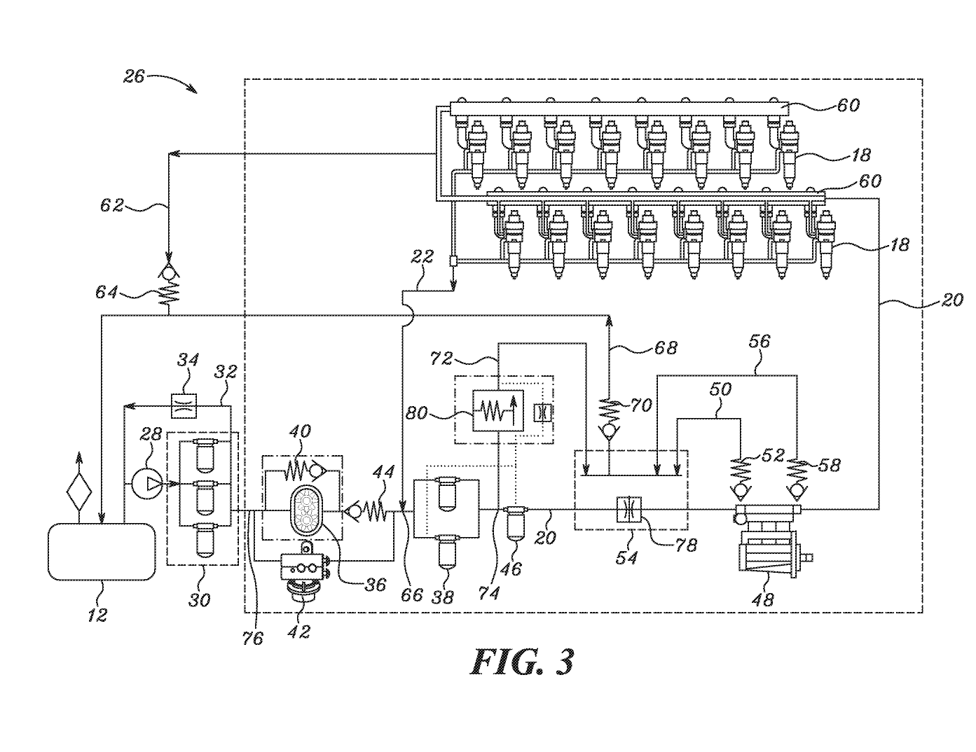

Referring to FIG. 3, in an alternate configuration, the re-circulating line 72 connects the outlet 74 of the second filter module 38 to the mono-block assembly 54 for re-circulating the fuel back to the fuel tank 12 via an orifice 78. In an embodiment, the re-circulating line 72 is installed with the pressure regulator 80.

### INDUSTRIAL APPLICABILITY

The fuel supply system 26 employs the fuel return line 22 that routes any fuel leakage in the fuel injector 18 to the inlet 66 of the second filter module 38. The leaked fuel passes through the second filter module 38, the third filter module 46, and consequently any contamination left in the fuel is filtered out before the fuel is transferred back to the fuel injector 18. Therefore, better filtration is achieved. Further, due to routing of the fuel leakage to the inlet 66 of the second filter module 38, the fuel supply system 26 is utilized without employing a conventional fuel injector back pressure regulator. Hence, the fuel supply system 26 avoids plugging of the fuel injector back pressure regulator occurring due to accumulation of debris or dirt around the injector back pressure regulator. Additionally, the flow line 32 directs any leaked fuel from the first filter module 30 to the fuel tank 12 via the orifice 34, thereby re-circulating the fuel in the fuel supply system 26 and re-using the fuel avoiding any wastage of fuel.

Also, the fuel supply system 26 maintains a consistent back pressure in the fuel injector 18 than the conventional fuel supply system with injector back pressure regulator, achieving better performance of the fuel injector 18.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A fuel supply system for an internal combustion engine, the fuel supply system comprising:
a fuel supply line adapted to supply fuel from a fuel tank to at least one fuel injector, the fuel supply line supplies the fuel via a first pump, a first filter module, a second pump, a second filter module, a third filter module and a third pump; and
a fuel return line adapted to return the fuel from the at least one fuel injector to an inlet of the second filter module;
wherein the fuel returned from the at least one fuel injector and supplied to the second filter module facilitates in maintaining a consistent back pressure and removing debris from the fuel supply system.
